(19) United States
(12) Patent Application Publication
(10) Pub. No.: US 2008/0103864 A1
(43) Pub. Date: May 1, 2008

(54) Model Generation and Distribution System

(75) Inventor: Dale Edward Mooney, Hamilton (NZ)

Correspondence Address: GREER, BURNS & CRAIN, 300 S WACKER DR, 25TH FLOOR, CHICAGO, IL, 60606, US

(73) Assignee: HGM DESIGN LIMITED, PENROSE, AUCKLAND (NZ)

(21) Appl. No.: 11/660,634

(22) PCT Filed: Aug. 17, 2005
(86) PCT No.: PCT/NZ05/00212

§ 371 Date: Jul. 31, 2007

(30) Foreign Application Priority Data
Aug. 18, 2004 (NZ) 534677

(51) Int. Cl. G06F 17/30; G06T 17/00; G06F 15/16; H04N 1/00

(52) U.S. Cl. 705/8; 345/419; 358/407

(57) ABSTRACT

A method of distributing 3-dimensional model data, the model data being associated with a physical item, the method of distribution including the steps of: (i) storing at a central data store full 3-dimensional model data; (ii) receiving at the central data store a request for abridged model data in a selected format from a requesting end user; (iii) generating at the central data store abridged model data in the selected format requested by the requesting end user; and (iv) transmitting the abridged model data in the selected format to the requesting end user.

### TECHNICAL FIELD

This invention relates to a model generation and distribution system. Reference throughout this specification will also be made to the present invention being used in this application but those skilled in the art should appreciate that other applications are also envisaged.

### BACKGROUND ART

Most people prefer to view, inspect, size or test a product before they purchase it. In the case of apparel, jewellery, eyeglasses or other products which are worn, a prospective customer will normally want to try wearing these products prior to the purchase to ensure they fit correctly and do not appear visually unattractive.

Mail order catalogues or internet web pages can be used to present images of such products and to give the user the ability to order and purchase products. However, these purchasing channels do not necessarily provide a purchaser with specific information regarding how the product will appear when worn, and furthermore, whether the sizes available for a product will fit the purchaser.

An alternative approach to the above is for a potential purchaser to visit a retail store which holds physical stock of a number of different products. A customer can try on apparel, jewellery or other products to be worn and immediately assess whether these products will suit them.

However, there are again some problems associated with this approach to vending products. Again, the potential customer is limited to viewing only the products which a retailer holds in stock at the time they visit. There is also generally no facility for a potential customer to explore customised or redesigned products adapted to suit their own tastes, and to have their design work displayed to them as it would appear when worn.

Furthermore, holding physical stock items can also increase the costs of the retailer which are subsequently passed onto the customer. Storage, security and also insurance costs must be recovered by retailers who hold stocks of products. One attempt to address this issue has been through the service offered and described in the internet address, http://www.myvirtualmodel.com. This website describes the formation of a virtual user model to be used with electronic retailing and on-line shopping applications. A user can select and input general body shape and dimensions information such as the height, weight or approximate build and body shape to generate such a virtual model. This service provides the ability to generate an approximate model form for a user with the format of the data generated being customised for use by electronic commerce systems specifically adapted to receive ‘myvirtualmodel’ data.

However, there are some limitations associated with this type of implementation of a ‘virtual model’.

The ‘myvirtualmodel’ implementation generates customised model data which presently may only be employed by specific electronic commerce retail applications. Such models can only be used by customers on the websites of the partners or licensees of the virtual model technology involved.

Furthermore, this facility provides an approximate model form only. The dimensions, shape and appearance of the model are generalised and also rely on a user's self image to supply data to build the model required. This therefore can result in a relatively generalised and also potentially inaccurate model being built in conjunction with such a system.

It is however possible to generate an accurate 3-dimensional virtual model through use of known laser based scanning technology. 3-dimensional virtual models may be generated using laser range finding systems which are highly accurate and which can be scanned over the entire surface of a person or object to be modelled.

However, these high accurate model generation systems in turn produce relatively large model based computer files to be stored and manipulated by appropriate computer software. The high accuracy and resolution of the model generated requires a relatively large file size to be stored which can result in file handling, processing and management complications. Such large files cannot necessarily be used effectively on low end or low cost computer systems, nor can they readily be transmitted electronically easily or quickly.

It would be preferable to have a model generation and distribution system or apparatus which addressed any or all of the above problems. Specifically, a model generation and distribution system which could provide the facility for a potential customer to visualise a range of products as they would appear when worn by the customer or user without necessarily having to provide physical access to such products would be of advantage. Furthermore, a model generation and distribution system which could allow a potential customer to explore numerous customised design modification options and to visualise same without necessarily having to have the new design assembled or fabricated would also be of advantage.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

It is an object of the present invention to address the foregoing problems or at least to provide the public with a useful choice.

Further aspects and advantages of the present invention will become apparent from the ensuing description which is given by way of example only.

### DISCLOSURE OF INVENTION

According to one aspect of the present invention there is provided a method of distributing 3-dimensional model data, said model data being associated with a physical item characterised by the steps of:
(i) storing at a central data store full 3-dimensional model data, and
(ii) receiving at said central data store a request for abridged model data in a selected format from a requesting end user, and
(iii) generating at said central data store abridged model data in the selected format requested by the requesting end user, and
(iv) transmitting said abridged model data in the selected format to the requesting end user.

According to another aspect of the present invention there is provided a method of generating and distributing 3-dimensional model data, said model data being associated with a physical item characterised by the steps of:
(i) generating full 3-dimensional model data using a scan operation, and
(ii) transmitting said full model data to a central data store, and
(iii) receiving at said central data store a request for abridged model data from a requesting end user, and
(iv) transmitting abridged model data from said central data store to said requesting end user.

According to further aspects of the present invention there are provided computer executable instructions stored on a computer readable medium adapted to execute the steps of;
(i) receiving a request for abridged model data in a selected format from a requesting end user, and
(ii) generating abridged model data in the selected format requested by the requesting end user from stored full 3-dimensional model data, and
(iii) transmitting said abridged model data in the selected format to the requesting end user.

According to another aspect of the present invention there is provided computer executable instructions stored on a computer readable medium adapted to execute the steps of;
(i) transmitting a request for abridged model data in a selected format, said request being received from a requesting end user, and
(ii) receiving abridged model data transmitted from a central data store, said abridged model data being formatted in the selected format requested.

According to another aspect of the present invention there is provided a model generation and distribution system which includes a processing means programmed with computer executable instructions adapted to execute a method substantially as described above.

The present invention is preferably adapted to provide at least a method of distributing 3-dimensional model data. Such model data can be used to represent physical dimensions, form and/or in some instances the texture or appearance of an exterior surface of a physical article, component, item or person. Such virtual 3-dimensional model data can be used in many and varied applications to eliminate the need for the physical item or article modelled to be present for assessment and consideration at a specific particular physical location.

Reference throughout this specification will in the main be made to the present invention providing a method of distributing 3-dimensional model data. However, those skilled in the art should obviously appreciate that computer executable instructions programmed into or run by a computer system which implement such a method are also within the scope of the present invention. For the sake of convenience the methodology of the present invention is discussed below and should readily be understood that appropriately programmed computer systems as well as the computer executable instructions themselves also form part of the present invention.

In the main the present invention will also be discussed as being implemented through client/server architecture, with transmissions being made between client and server applications. Those skilled in the art should appreciate that the majority of the information processing required to implement the present invention may be completed via a server application, but that a client application is also within the ambit of the present invention.

Reference throughout this specification will also be made to an end user of the model generation and distribution system being a person who wishes to assess the visual appearance of a product when worn by themselves. However, it should also be appreciated that the end user or operator of the present invention may not necessarily be the wearer of the product involved, and can in some instances be the sales staff of a retailer who can assist a potential customer. However, the present invention may be used to provide a model of any particular physical article, component, item or person for use in varied applications. Those skilled in the art should appreciate that such models need not necessarily be used exclusively to illustrate the appearance of products when worn by a model of the user. Reference to the above only in the main throughout this specification should in no way be seen as limiting.

Preferably the present invention may employ a central data store which is adapted to receive, store and also subsequently distribute 3-dimensional model data. Such a data store may preferably be adapted to receive and store full 3-dimensional model data, being highly accurate and highly resolved model data generated from a scanning operation executed on a particular item, article or person to be modelled. Such full model data may consist of or provide the most accurate, precise or highest quality possible model available for the item, person or article to be modelled.

In a further preferred embodiment the central data store may incorporate or employ a database to store all 3-dimensional model data. Database technology is well known in the art, and can be used to index, store and retrieve large numbers of full 3-dimensional model data sets, in addition to having the capacity to assist in the storage of comparatively large full 3-dimensional model data sets.

Preferably, the present invention may be adapted to distribute or transmit abridged model data on demand or at the request of a requesting end user. Abridged model data may be generated, stored or otherwise sourced from the central data store for subsequent supply to a requested end user.

Preferably abridged model data may again provide the facility or capacity to model a specific article, component or person but may not necessarily provide the highest quality resolution or accuracy model when used. The accuracy or quality of the model available may be sacrificed with abridged model data to reduce the size, volume or amount of abridged model data which needs to be provided to implement an effective model. Such abridged model data may be generated, for example, in some instances through discarding portions of a full 3-dimensional model data set or alternatively by averaging portions of a full 3-dimensional model set prior to providing an approximate abridged 3-dimensional model data set.

Preferably the central data store may be adapted to receive a request or requests for abridged model data from a requesting end user. A requesting end user may preferably trigger the on-demand transmission of abridged model data from a central data store as and when required by the requesting end user. An end user may request abridged model data in a selected format to be used with a specific application or process currently of interest to the end user.

For example, in one preferred embodiment, various Internet based retail websites may provide the facility for a user to view products to be worn by a user. An abridged model data set representing the form, appearance and physical dimensions of the end user's body can be employed to illustrate the appearance of the product in question when worn by a user. The provision of abridged model data sets reduces the size or volume of information which needs to be transmitted to a user to facilitate such modelling applications, thereby simplifying and substantially speeding the transmission process involved.

Alternatively in other embodiments the central data store may host model data associated with a particular product retailed or vended by a supplier. Abridged and formatted product model data may then be transmitted on demand from the central data store, either to a potential customer or to an in-house product display system maintained or run by the supplier involved.

Reference throughout this specification will also be made to abridged model data being used in such applications, but those skilled in the art should appreciate that alternative uses are also considered for same. For example, abridged model data may be employed to form or implement a model for a specific part or components of a piece of machinery where the model provided can in turn be used to facilitate cost estimates for manufacturing such a part, or alternatively facilitate the manufacturing the part itself if required.

In a preferred embodiment, a user's requests for abridged model data may be transmitted to the central data store using well known internet protocol transmissions. Internet protocol transmissions can be implemented using well known computer based network transmission systems, such as for example, email or http applications. Those skilled in the art should also appreciate that various transmission protocols or computer networks and computer network transmissions may also be employed in conjunction with the present invention to make such an end user request for abridged model data.

Preferably an end user request for abridged model data may also specify a selected format within which the abridged model data is to be organised or formatted. This selected format may be dictated in turn by the application with which the requesting end user wishes to employ the abridged model data to allow such an application to function effectively.

In a preferred embodiment the central data store may be configured or adapted to store only full 3-dimensional model data sets. The central data store may include a processing capacity or facility which can allow for the generation of abridged 3-dimensional model data sets in a selected or specified selected format dictated by the end user's request. In such embodiments a specific format abridged model data set may be generated on demand at the central data store using a stored full 3-dimensional model data set as input to the generation process executed. The processing facility or capacity of the central data store may be adapted to generate selected or varied formats of model data which are commonly known and used in many varied modelling applications.

In a preferred embodiment, the central data store may also generate abridged model data sets of a size indicated or dictated by an end user's request.

Preferably once abridged model data in the selected format indicated by an end user is available, this data set may in turn be transmitted to the end user. preferably internet protocol transmissions made over computer networks may be employed to deliver such abridged model data to an end user. Again, as discussed above, many varied and differing transmission protocols and channels may be employed to make such transmissions in conjunction with the present invention. The reduction in size and complexity of the abridged model data may allow such transmissions to be completed comparatively quickly or using low bandwidth connections with a reduced probability of transmission errors occurring.

In a further preferred embodiment the present invention may also encompass a method of both generating and then subsequently distributing 3-dimensional model data. In such instances the present invention may also employ or facilitate the execution of a scan operation where the object, article or person to be modelled is scanned by specific hardware or components used to generate a full 3-dimensional model data set. Such a scanning operation may be executed once per object, item or person to be modelled with the subsequent resulting full model data set being easily distributed and re-used in accordance with the present invention.

In a further preferred embodiment, full 3-dimensional model data set generated by a scan operation may in turn be transmitted to the central data store using internet protocol transmissions. Preferably a high bandwidth channel or link may be provided between the scanning site or location and the central data store to facilitate such transmissions of the relatively large full 3-dimensional model data sets involved.

The present invention may provide many potential advantages over existing methods and systems used to model physical articles, and to distribute such models.

The present invention may provide an improved method of distributing 3-dimensional model data. The model data distributed may be customised and preferably reformed to suit any number of different applications within which a user requesting model data may be interested. Preferably the present invention may be employed to distribute abridged model data for numerous and varied different applications where this abridged data has a size substantially smaller than full model data, greatly simplifying the transmission of same using computer networks.

The present invention may also encompass a method of both generating such 3-dimensional model data through a scan operation in addition to distributing same through abridged model data on request. Furthermore, the model data provided may be used in many and varied applications depending on the needs of a requesting user. For example, in one preferred instance, such model data may be used in conjunction with additional models or products which can be worn by a user. The two models involved may be combined together to give a user an indication of how a particular product will appear when worn by themselves.

A method, software or apparatus for displaying a product as configured in accordance with the present invention can allow a product to be displayed to a user without necessarily requiring the user to have physical access to the product in question. This can limit the extent to which a retailer needs to hold physical stock items and also in some instances, can allow a user to shop or peruse products using a computer system and internet connection.

The real time rendering of modified images provided in accordance with the present invention can also allow an end user to explore design options and customised changes to be made to products prior to the fabrication and purchase of such products.

It should also be appreciated that the invention as described above also provides a method of doing business that is unique over what is currently available in the retail service industry.

By allowing a user to try on an item and decide on suitability and style without actually needing to have the piece physically in stock, a number of advantages are realised. Firstly, the amount of stock a shop needs to carry is reduced. The need to carry a variety of sizes of the same style is effectively eliminated. Only one size need be carried to illustrate the actual physical item, this being particularly relevant for jewellery containing diamonds or the like where a particular cut will catch light in different ways.

Furthermore, due to the reduced amount of stock required, the amount of insurance required to cover contents and risk is able to be reduced. Accordingly, reduced stock on site would result in a reduced likelihood of burglary, as the risk versus potential returns would be reduced for the would-be burglar.

As the level of insurance required would be reduced, the price of stock could be reduced, or greater security be put in place, or other aspects of the service upgraded, providing an overall improvement to the industry as a whole.

### BRIEF DESCRIPTION OF DRAWINGS

Further aspects of the present invention will become apparent from the ensuing description which is given by way of example only and with reference to the accompanying drawings in which:

FIG. 1 shows a schematic block flow diagram of components employed and information flows used with conjunction and method of generating and distributing 3-dimensional model data in conjunction with a preferred embodiment of the present invention; and

FIG. 2 shows a block schematic flowchart of steps executed and information transferred in relation to a basic method of distributing 3-dimensional model data implemented in a further embodiment of the present invention.

### BEST MODES FOR CARRYING OUT THE INVENTION

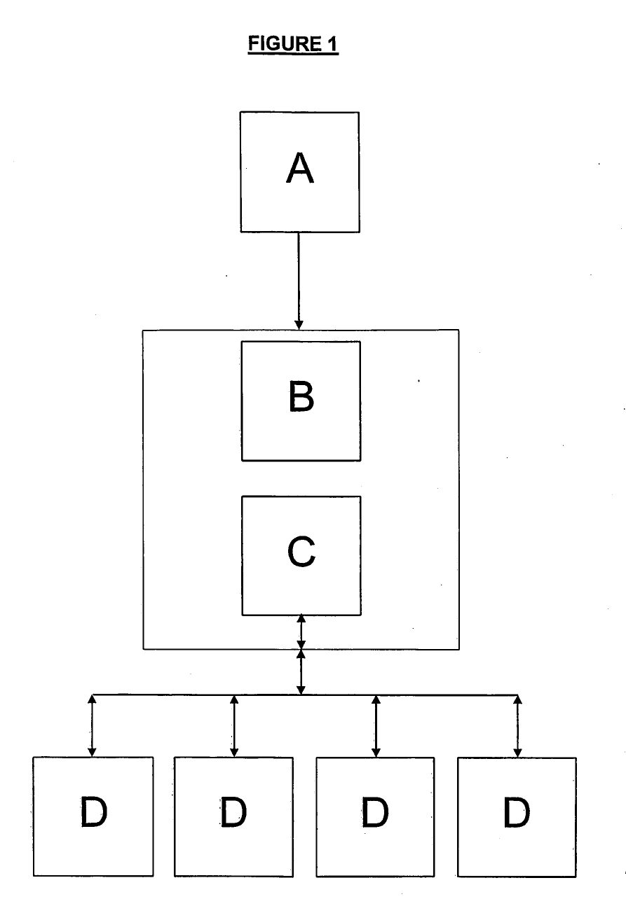

FIG. 1 shows a schematic block flow diagram of components employed and information flows used with conjunction and method of generating and distributing 3-dimensional model data in conjunction with a preferred embodiment of the present invention.

In the flowchart shown, at stage A, an initial scanning operation is completed to generate a full 3-dimensional model data set. This full data set and is of a high quality or high resolution and can provide the best quality possible model over a particular article, or preferably a person's body.

At stage B of this process, the full 3-dimensional model data set is transmitted or otherwise conveyed to a central data store and stored within same. The data store may provide for the storage of such 3-dimensional model data sets indefinitely and can also preferably allow access to same on request.

At stage C of the flowchart illustrated, a re-purposing or re-formatting operation is completed within the central data store to generate an abridged model data set on receipt of request from a requesting end user. The requests received from end users preferably specify a particular or selected format for the abridged model data and also in some instances a maximum size, resolution or quality for such abridged model data sets.

After an abridged model data set has been generated in step C, in step D this abridged model data set is transmitted to the requesting end user involved. Preferably these transmissions are made using standard computer network protocols and infrastructure to allow the abridged model data sets delivered to be subsequently used by an end user's computer hardware to interface with an electronic commerce retail website or other similar facility.

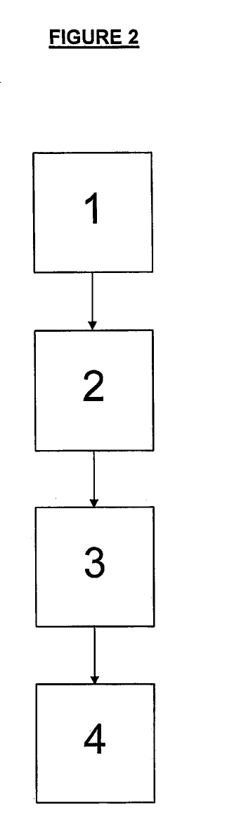

FIG. 2 shows a block schematic flowchart of steps executed and information transferred in relation to a basic method of distributing 3-dimensional model data for a further embodiment of the present invention.

The first step (1) of the method executed is the receipt of a request for abridged model data from a requesting end user of the system. This request consists of an indication of the format in which abridged data is to be supplied in addition to a size parameter for the overall abridged model data set which the user would like to receive.

The second stage of this process (2) the full 3-dimensional model data stored at a data store remote from the user is retrieved.

At stage (3) of this process, the retrieved full model data is repurposed or reformatted into the abridged model data requested by the end user at stage (1). The reformatted abridged data is placed in a format selected or requested by the end user and is reduced in size to below a maximum file size indicated by the end user.

At stage (4) of this process, the abridged model data set is transmitted to the end user using standard computer network technology and infrastructure.

Aspects of the present invention have been described by way of example only and it should be appreciated that modifications and additions may be made thereto without departing from the scope thereof as defined in the appended claims.

1. A method of distributing 3-dimensional model data, said model data being associated with a physical item, the method of distribution being including the steps of:
(i) storing at a central data store captured 3-dimensional model data;
(ii) receiving at said central data store a request for abridged model data in a selected format from a requesting end user;
(iii) generating at said central data store abridged model data in the selected format requested by the requesting end user; and
(iv) transmitting said abridged model data in the selected format to the requesting end user.

2. A method of distributing 3-dimensional model data as claimed in claim 1, wherein model data is used to represent the dimensions of a physical item.

3. A method of distributing 3-dimensional model data as claimed in claim 1, wherein model data is used to represent at least one texture associated with the exterior surface of a physical article.

4. A method of distributing 3-dimensional model data as claimed in claim 1, wherein the central data store incorporates a database.

5. A method of distributing 3-dimensional model data as claimed in claim 1, wherein abridged model data is generated through discarding portions of a captured 3-dimensional model data set.

6. A method of distributing 3-dimensional model data as claimed in claim 1, wherein abridged model data is generated by averaging portions of a captured 3-dimensional model data set.

7. A method of distributing 3-dimensional model data as claimed in claim 1, wherein abridged model data is transmitted from the central data store using internet protocol transmissions.

8. A method of distributing 3-dimensional model data as claimed in claim 1, wherein an end user's request for abridged model data is transmitted to the central data store using internet protocol transmissions.

9. A method of distributing 3-dimensional model data as claimed in claim 1, wherein an end user's request for abridged model data specifies a selected format for said abridged model data.

10. A method of distributing 3-dimensional model data as claimed in claim 1, wherein an end user's request for abridged model data includes a size for the abridged model data set requested.

11. A method of generating and distributing 3-dimensional model data, said model data being associated with a physical item, the method including the steps of:
(i) generating captured 3-dimensional model data using a scan operation;
(ii) transmitting said captured 3-dimensional model data to a central data store;
(iii) receiving at said central data store a request for abridged model data from a requesting end user; and
(iv) transmitting abridged model data from said central data store to said requesting end user in response to said request for abridged model data.

12. A method of distributing 3-dimensional model data as claimed in claim 11, wherein captured 3-dimensional model data generated by a scan operation is transmitted to the central data store using internet protocol transmissions.

13. Computer executable instructions stored on a computer readable medium adapted to execute the steps of:
(i) receiving a request for abridged model data in a selected format from a requesting end user;
(ii) generating abridged model data in the selected format requested by the requesting end user from stored captured 3-dimensional model data; and
(iii) transmitting said abridged model data in the selected format to the requesting end user in response to said request for abridged model data.

14. A model distribution system programmed to execute computer executable instructions as claimed in claim 13.

15. Computer executable instructions stored on a computer readable medium adapted to execute a method of receiving distributed 3-dimensional data, said model data being associated with a physical item, the method including:
(i) transmitting a request for abridged 3-dimensional model data in a selected format, said request being received from a requesting end user; and
(ii) receiving abridged 3-dimensional model data transmitted from a central data store, said abridged model data being formatted in the selected format requested.

16. A model distribution system which includes a processing means loaded with software adapted to execute a method of distributing 3-dimensional model data as claimed 1.

17. (canceled)

18. (canceled)
